(19) United States
(12) Patent Application Publication
(10) Pub. No.: US 2008/0320131 A1
(43) Pub. Date: Dec. 25, 2008

(54) Method, Apparatus or Software for Managing Propagation of the Performance of a Node in a Network

(75) Inventors: Blair Chalmers, Newcastle (GB); Marvin Richard Klein, Boston, MA (US); Dale Lane, Eastleigh (GB); James Thomas, Didsbury (GB); Matthew Whitbourne, Horndean (GB); Emlyn Whittick, Llanidloes (GB)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 12/142,961

(22) Filed: Jun. 20, 2008

(30) Foreign Application Priority Data
Jun. 22, 2007 (GB) 07110883.1

(51) Int. Cl. G06F 15/173

(52) U.S. Cl. 709/224

(57) ABSTRACT

A method, apparatus and software are disclosed for managing a network of nodes in a manner that enables the effect of the performance of one node on its neighbouring nodes in the network to be controlled.

### FIELD OF INVENTION

The present invention relates to a method, apparatus or software for managing propagation of the performance from a node in a network.

### BACKGROUND OF THE INVENTION

Network management systems are commonly applied to manage the performance of a network. Such systems may be employed in many different types of network such as computer or communications networks, virtual networks, social networks and to any such network provided in a virtual world. One function of network management systems is to identify undesirable performance or behaviors originating from one or more nodes in the network so as to enable the performance or behavior to be corrected or otherwise managed. Often, undesirable performance from one node will have an influence on performance at neighbouring or connected nodes.

Network management systems are provided that enable a node exhibiting undesirable performance or behavior to be excluded or isolated from the network. For example, in a communications network, the node, in the form of a computer, may be disconnected from the network. Similarly, in a social network, a node, in the form of a participant, may be excluded from a social network by having their access rights revoked. However, such systems do not provide a mechanism for managing such undesirable behavior while maintaining the node exhibiting the behavior within the network.

### SUMMARY OF THE INVENTION

An embodiment of the invention provides a method for managing propagation of the performance of a node in a network, the method comprising the steps of:
a) determining one or more performance measures for each of a plurality of nodes in a network, at least one of the performance measures being arranged to measure a performance that propagates via the network from one node to another node;
b) monitoring the performance of each node in the network;
c) identifying any one or more of the nodes meeting one or more of the performance measures; and
d) reorganising the relative positions of one or more nodes on the network so as to modify the probability of propagation of the performance of the or each identified node to other nodes in the network.

The relative positions may be reorganized to reduce the probability of propagation. The relative positions may be reorganized to increase the probability of propagation. The relative positions of the nodes on the network may represent relative physical positions of the nodes in a physical geography. The network connections between the nodes may represent possible routes of the propagation of the performance between the nodes. The probability of the propagation may be determined, at least in part, by one or more features of the network connections. At least one of the performance measures may be a measure of human behavior. The probability of the propagation between nodes may be determined, at least in part, by one or more features of the respective nodes.

Another embodiment provides apparatus for managing propagation of the performance of a node in a network, the being operable to:
determine one or more performance measures for each of a plurality of nodes in a network, at least one of the performance measures being arranged to measure a performance that propagates via the network from one node to another node;
monitor the performance of each node in the network;
identify any one or more of the nodes meeting one or more of the performance measures; and
reorganize the relative positions of one or more nodes on the network so as to modify the probability of propagation of the performance of the or each identified node to other nodes in the network.

A further embodiment provides a group of one or more programs arranged to enable a group of one or more programmable devices to perform a method for managing propagation of the performance of a node in a network, the method comprising the steps of:
a) determining one or more performance measures for each of a plurality of nodes in a network, at least one of the performance measures being arranged to measure a performance that propagates via the network from one node to another node;
b) monitoring the performance of each node in the network;
c) identifying any one or more of the nodes meeting one or more of the performance measures; and
d) reorganising the relative positions of one or more nodes on the network so as to modify the probability of propagation of the performance of the or each identified node to other nodes in the network.

Another embodiment provides a group of one or more programs arranged to enable a group of one or more programmable devices to provide apparatus for managing propagation of the performance of a node in a network, the being operable to:
determine one or more performance measures for each of a plurality of nodes in a network, at least one of the performance measures being arranged to measure a performance that propagates via the network from one node to another node;
monitor the performance of each node in the network;
identify any one or more of the nodes meeting one or more of the performance measures; and
reorganize the relative positions of one or more nodes on the network so as to modify the probability of propagation of the performance of the or each identified node to other nodes in the network.

### BRIEF DESCRIPTION OF THE DRAWINGS

Embodiments of the invention will now be described, by way of example only, with reference to the accompanying drawings in which:

FIG. 1 is a schematic illustration of a network management system for managing a network of nodes;

FIG. 2 is a map of the relative physical position of nodes locations in the network of FIG. 1;

FIG. 3 is a schematic illustration of the functional elements of the network management system of FIG. 1;

FIGS. 4a and 4b are illustrations of an example of the reorganisation of the network of FIG. 1; and

FIG. 5 is a flow chart illustrating processing performed by the management system of FIG. 1.

### DETAILED DESCRIPTION OF PREFERRED EMBODIMENTS OF THE INVENTION

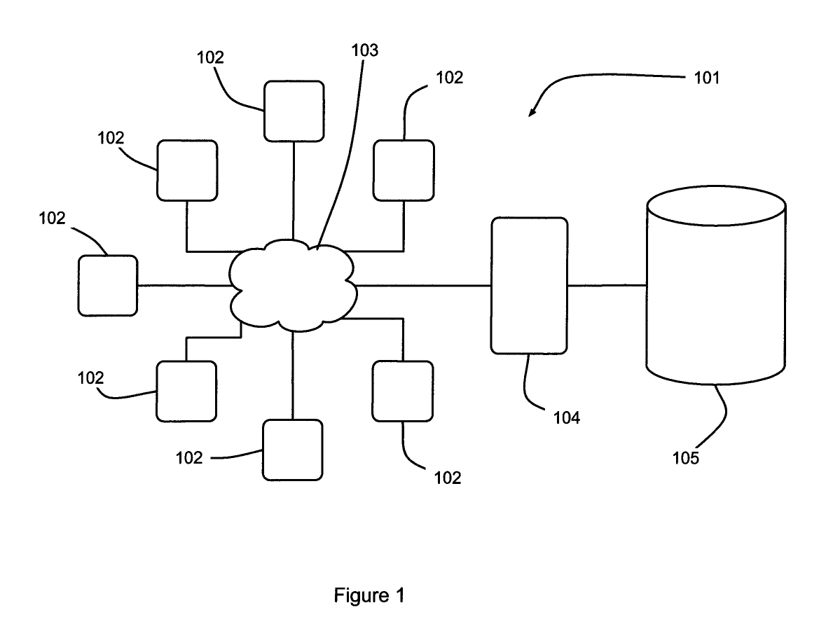

With respect to FIG. 1, a computer system 101 comprises a set of first computers 102 interconnected via a network 103. A second computer 104 is connected to a storage device 105 and also to the network 103. In the present embodiment, the first computers 102 provide classroom workstations for a set of users via respective workstation application programs. In the present embodiment, the users are the nodes of the network and the workstations 102 provide physical locations for the users in the network. The second computer 104 provides a network management server via a network management application program (shown later). The network management server 104 is arranged to monitor the working patterns of the users of the workstations 102 so as to identify undesirable performance or behavior, such as copying or plagiarism. In response to identifying any such performance or behavior, the network management server 104 is arranged to automatically reorganize the network 103 so as to mitigate the impact of undesirable behavior on the users of the other workstations 102. In the present embodiment, the network management server 104 is arranged to reorganize the network 103 by controlling the access of the users to the workstations 102.

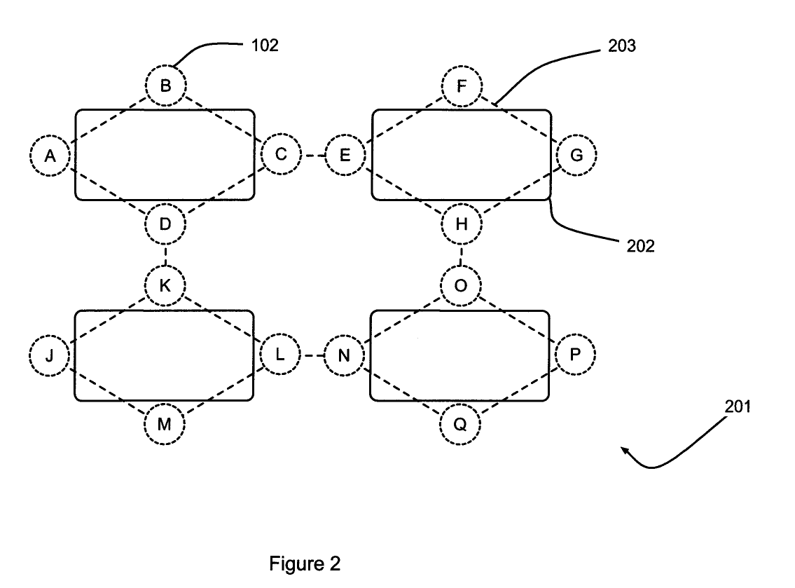

With reference to FIG. 2, the network management server 104 is provided with a map 201 of the possible physical locations of the network nodes, in the form of the workstations 102. The locations of the workstations 102 are represented as vertices (A to Q) relative to their physical geography, that is, the desks 202 of the classroom on which the workstations 102 are placed. In addition, the physical communications routes 203 between users when at a given workstation are identified as edges between the vertices.

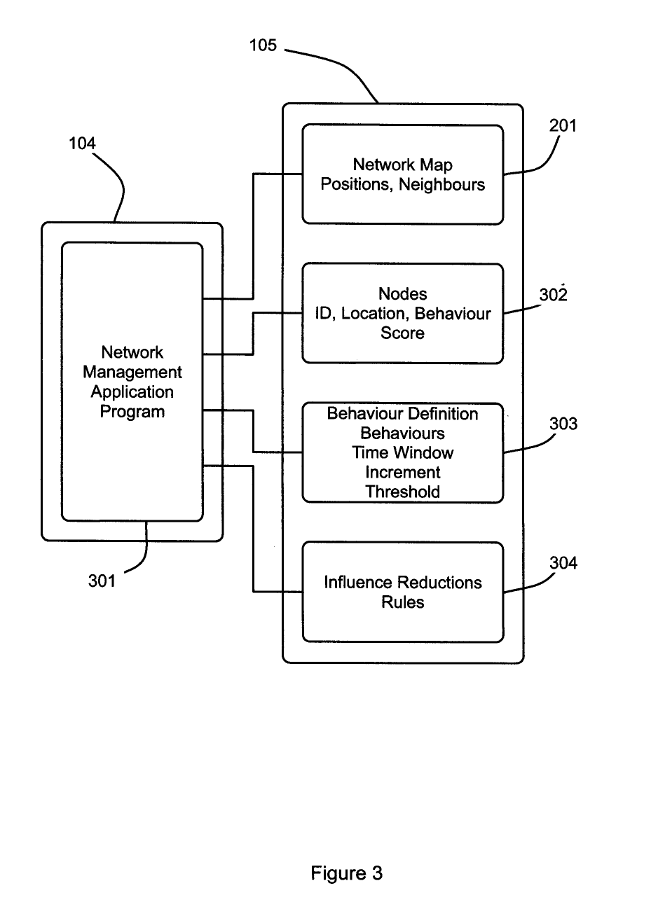

FIG. 3 shows the network management application program 301 installed on the server computer 104. The map 201 is stored on the storage device 105 in the form of a list of the workstations (A to Q) 102 coupled to a list identifying the neighbours of each workstation. In addition, the storage device holds node data 302, a set of behavior definitions 303 and a set of influence reduction rules 304. The user data 302 comprises:
Node ID—a unique identifier for each node or user;
Node Location—the current location or assigned workstation (A to Q) 102 for the node; and
Node Behavior Score—a score determining whether the user's behavior is within acceptable bounds.

The behavior definitions 303 define:
Behaviors—a definition of the characteristics of the behavior to be monitored;
Time Window—the time window over which the behavior is monitored before being scored;
Increment/Decrement—the increment applied at the end of each time window to a node behavior score applied if that node exhibits the defined behavior or a corresponding decrement for failing to exhibit the behavior; and
Threshold—a behavior threshold that defines the limit, in terms of node behavior score, between acceptable and unacceptable behavior for a given node.

The influence reduction rules 304 define the action performed by the network management application program 301 in response to a given node exhibiting a behavior score above the defined threshold for the given behavior. The rules 304 are arranged to reduce the effect that the behavior of an offending node may have on its neighbouring nodes. For example, a node may be assigned or restricted to workstations more distant from workstations occupied by other nodes or least well connected to workstations occupied by other nodes via the physical communications routes 203.

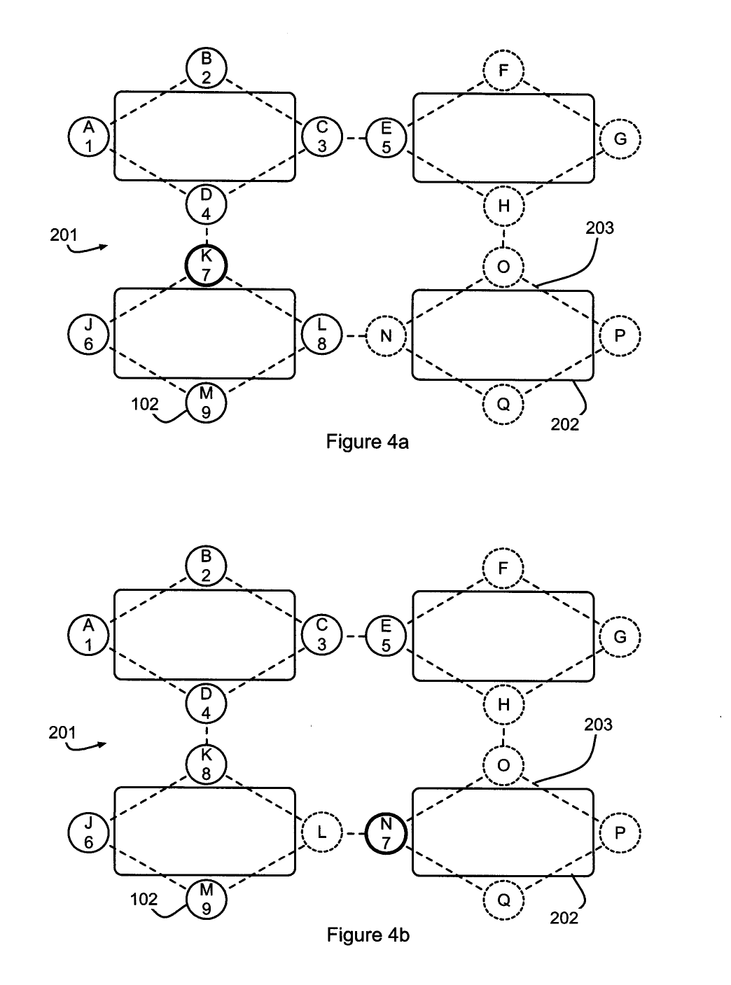

FIGS. 4a and 4b illustrate an example of the application of an influence reduction rule 304. With reference to FIG. 4a, users with user IDs 1 to 9 are logged on to workstations A to F and J to L respectively. Unoccupied workstations 102 are shown in FIGS. 2, 4a and 4b with a dotted outline while occupied workstations are shown with a solid outline. In this example, the user 7 is logged on to workstation K and has attained a behavior score above the threshold for the monitored behavior. This causes the network management application program 301 to reorganize the allocation of workstations 102 to the users, in accordance with the influence reduction rules 304. In the present example, the influence reduction rules 304 define that a node exhibiting undesirable behavior is moved to the nearest workstation having at least one unused workstation between it and any occupied workstation. FIG. 4b illustrates the rearranged network in which the user 8 has been moved to workstation K and the offending user 7 has been moved to workstation N. The revised network arrangement reduces the probability of any continued undesirable behavior of the offending user on other users via the physical communication paths 203.

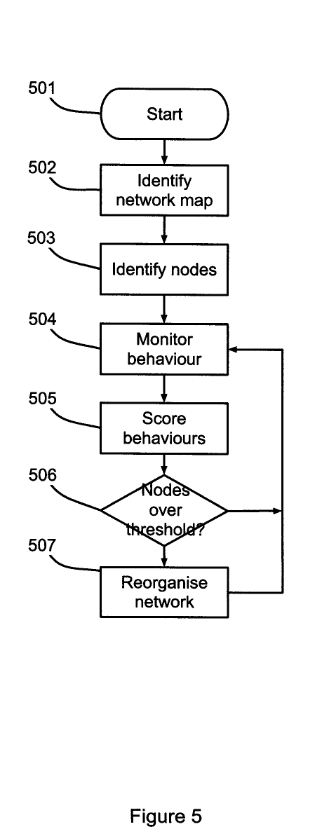

The processing performed by the network management application program 301 when monitoring the behavior of nodes on the network will now be described in further detail with reference to FIG. 5. At step 501, the program is initiated and processing moves to step 502 where the network map 201 is identified. Processing then moves to step 503 where the nodes attached to the network are identified from the user data 302. Processing then moves to step 504 where the behavior of the attached nodes is monitored for the appropriate time window in accordance with the behavior definitions 303. When the time window has elapsed, processing moves to step 505 where the behavior score for each node is updated in accordance with their monitored behavior and the behavior definitions 303. Processing then moves to step 506 where, if the behavior score of any of the nodes has exceeded the behavior score threshold then processing moves to step 507 where the network is reorganized, in accordance with the influence reduction rules 304, to ensure that each node having exceeded the behavior score threshold is relocated on the network relative to other nodes so as to reduce the probability of subsequent undesirable behavior propagated to other nodes in the network. Processing then returns to step 504 to continue monitoring the behavior as described above. If at step 506 no nodes have exceed the behavior threshold then processing returns to step 504 as described above.

Thus embodiments of the invention enable undesirable performance or behavior in a network to be identified and its effect minimised by reorganising the network.

In another embodiment, the network comprises fixed nodes and the performance or behavior being monitored propagates via the management network itself as opposed to the physical communications paths described above. For example, the performance may be the network traffic volume or routing distance of messages emanating from a given node. In this embodiment, the network connection may be reconfigured in response to a given node exhibiting the monitored behavior. The network connections may be virtual or physical.

In a further embodiment, the network may be arranged within a virtual world or other virtual environment. For example, the network may be made up of nodes in the form of virtual world entities such as avatars. In such a virtual world space, a dynamic network map is generated based on the proximity of entities on a real map or scene graph. Such map data is commonly produced by virtual world or game engines. Thus, node interconnections in the network may be identified via proximity within the virtual space and bound according to physics engine rules. For example, two avatars next to each other will have a connection. However, if a virtual wall is defined between the two avatars then no connection would be present.

As will be understood by those skilled in the art, the propagation potential of a given node's behavior or performance on other nodes may be reduced by a number of mechanisms such as: redistributing nodes within the network, distancing an offending node from other nodes, distancing other nodes from the offending node, adding further nodes to effectively dilute the undesirable behavior, relocating the offending node near to other less easily influenced nodes. Instead of assigning nodes to particular network locations, the network may be divided into zones with restricted access to designated zones based on node behavior.

In another embodiment, desirable behavior is monitored and in response to the detection of a node exhibiting such behavior, the network is rearranged so as to increase the propagation potential for the behavior.

In a further embodiment, no behavior score threshold is implemented and any demonstration of the monitored behavior results in network reorganisation. In another embodiment a measure of node connectivity based on Eigenvector value or reach is used to determine the potential propagation of a behavior. In a further embodiment, nodes may be rated based on historical behavior records or by a heuristic based on a known characteristic. The rating may then be used in determining the potential propagation of a behavior of the node and thus enables the network to be organized so as to reduce the possibility of undesirable behavior occurring. In another embodiment, the behavior is monitored for a group of nodes. In a further embodiment, two or more behaviors are monitored for one or a group of nodes and the behaviors may all contribute to the behavior score for the nodes. In another embodiment, the monitored behavior or its propagation are represented graphically. In a further embodiment, the behavior definition defines a trigger instead of a threshold and a behavior score. In other words, a single occurrence of a behavior results in a reorganisation of the network. For example, the trigger may be set for the propagation of a keyword between nodes in the network.

As will be understood by those skilled in the art, the network nodes are effectively sensors through which the monitored behavior or performance is detected. The nodes may be computers, simple switches or other transducers or manual input.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method for managing a network, said method comprising the steps of:
a) determining at least one performance measure for each of a plurality of nodes in the network, with one performance measure being arranged to measure a propagation performance of a node that propagates via said network from one node to another node;
b) monitoring performance of each node in said network;
c) identifying any of said nodes that meet any of the at least one performance measure; and
d) reorganizing relative positions of at least one node of the nodes on said network so as to modify a probability of propagation of said propagation performance to other nodes in said network.

2. The method according to claim 1 wherein said reorganizing step further comprises:
in response to determining that said propagation performance is undesirable, reorganizing said relative positions to reduce said probability of said propagation.

3. The method according to claim 1 wherein said reorganizing step further comprises:
in response to determining that said propagation performance is desirable, reorganizing said relative positions to increase said probability of said propagation.

4. The method according to claim 1 in which the relative positions of said nodes on said network represent relative physical positions of said nodes in a physical geography.

5. The method according to claim 4 in which the network connections between said nodes represent possible routes of said propagation of said propagation performance between said nodes.

6. The method according to claim 5 in which said probability of said propagation is determined, at least in part, by at least feature of said network connections.

7. The method according to claim 1 in which the at least one performance measure is a measure of human behavior.

8. The method according to claim 6 in which said probability of said propagation between nodes is determined, at least in part, by at least one node feature.

9. An apparatus for managing a network, said apparatus comprising:
means for determining at least one performance measure for each of a plurality of nodes in the network, with one performance measure being arranged to measure a propagation performance of a node that propagates via said network from one node to another node;
means for monitoring performance of each node in said network;
means for identifying any of said nodes that meet any of the at least one performance measure; and
means for reorganizing relative positions of at least one node of the nodes on said network so as to modify a probability of propagation of said propagation performance to other nodes in said network.

10. The apparatus according to claim 9 wherein said means for reorganizing further comprises;
means, responsive to determining that said propagation performance is undesirable, for reorganizing said relative positions to reduce said probability of said propagation.

11. The apparatus according to claim 9 wherein said means for reorganizing further comprises:
means, responsive to determining that said propagation performance is desirable, for reorganizing said relative positions to increase said probability of said propagation.

12. The apparatus according to claim 9 in which the relative positions of said nodes on said network represent relative physical positions of said nodes in a physical geography.

13. The apparatus according to claim 12 in which the network connections between said nodes represent possible routes of said propagation of said propagation performance between said nodes.

14. The apparatus according to claim 13 in which said probability of said propagation is determined, at least in part, by at least one feature of said network connections.

15. The apparatus according to claim 9 in which the at least one performance measure is a measure of human behavior.

16. The apparatus according to claim 14 in which said probability of said propagation between nodes is determined, at least in part, by at least one node feature.

17. At least one software program stored on a storage means that enables at least one device to perform, when executed by the device, steps of:
a) determining at least one performance measure for each of a plurality of nodes in the network, with one performance measure being arranged to measure a propagation performance of a node that propagates via said network from one node to another node;
b) monitoring performance of each node in said network;
c) identifying any of said nodes that meet any of the at least one performance measure; and
d) reorganizing relative positions of at least one node of the nodes on said network so as to modify a probability of propagation of said propagation performance to other nodes in said network.

18. (canceled)
